(19) United States
(12) Patent Application Publication
(10) Pub. No.: US 2015/0306636 A1
(43) Pub. Date: Oct. 29, 2015

(54) CLEANING DEVICE

(71) Applicant: SHARP KABUSHIKI KAISHA, Osaka-shi, Osaka (JP)

(72) Inventors: Hideaki NAGURA, Osaka-shi (JP); Makoto HORIYAMA, Osaka-shi (JP); Yasuhiro SAKAMOTO, Osaka-shi (JP); Masaaki KODAMA, Osaka-shi (JP); Ryoji ISHIMURA, Osaka-shi (JP)

(21) Appl. No.: 14/651,757

(22) PCT Filed: Aug. 20, 2013
(86) PCT No.: PCT/JP2013/072190

§ 371 Date: Jun. 12, 2015

(30) Foreign Application Priority Data
Dec. 21, 2012 (JP) 2012-279452
Jun. 26, 2013 (JP) 2013-133399

(51) Int. Cl. B08B 1/00; H02S 40/10; B08B 3/02

(52) U.S. Cl. CPC B08B 1/008; B08B 3/024; H02S 40/10

(57) ABSTRACT

A cleaning device includes a nozzle that discharges water toward a light-receiving surface, and a blade that wipes away the water on the light-receiving surface. A hole in the nozzle is arranged so as to face the surface to be cleaned or arranged so as to be inclined to a side of the blade with respect to a reference plane.

### TECHNICAL FIELD

The present invention relates to a cleaning device, and particularly relates to a cleaning device that is able to be utilized suitably for cleaning of a solar panel.

### BACKGROUND ART

These days, the number of households that install a solar panel (photovoltaic cell) on a roof, which converts solar light to power, is increasing in consideration of environmental protection. Moreover, discussion on alternative energy of petroleum/nuclear power has been made globally, measures for Feed-in Tariff of renewable energy such as solar photovoltaic power generation have been implemented, and in corporations, municipalities, electric power companies and the like, by constructing a larger-scale solar photovoltaic power generation plant, generated power is being utilized in-house and electricity business by selling of power is being carried out.

The solar panel has been considered in the past to be capable of maintenance-free power generation because dirt on a surface is removed by rainfall or the like. However, since the solar panel generates power by receiving solar light, when fallen leaves or dirt such as dust are adhered onto the surface of the solar panel, an amount of power which is generated is rapidly reduced.

Moreover, in an area where a precipitation amount is small such as a desert/arid zone and an area where there are a lot of depositions of volcanic ashes, yellow sand, snow or the like, cleaning (cleanup) operation is performed because of necessity of cleaning dirt on the surface of the solar panel in order to generate power efficiently throughout the year.

Examples of a cleaning device which cleans a solar panel include ones disclosed in PTL 1 and PTL 2.

FIG. 8 is a top view showing a related art solar panel cleaning device 30 disclosed in PTL 1. As shown in FIG. 8, the cleaning device 30 is provided with gears on two opposing sides of a frame 31 that is fixed to a solar panel 301 and an electrically-operated vehicle 32 moves on the gears. Thereby, the solar panel 301 is cleaned by feeding and ejecting water from a cleaning hose 34 while the cleaning device 30 is rotationally moving a cleaning mop 33 or the like.

Moreover, a solar panel cleaning device disclosed in PTL 2 includes self-propelled quadrupedal means that moves on a solar panel while cleaning the solar panel by using a cleaning member such as a brush and a blade. Moreover, a high-pressure cleaning mechanism that ejects water at high pressure toward a surface of the solar panel is provided so that it is possible to remove dirt which is stuck fast to the surface.

### CITATION LIST

### Patent Literatures

PTL 1: Japanese Unexamined Patent Application Publication No. 2010-287867 (Publication date: Dec. 24, 2010)

PTL 2: Japanese Unexamined Patent Application Publication No. 2010-186819 (Publication date: Aug. 26, 2010)

### SUMMARY OF INVENTION

### Technical Problem

Meanwhile, in the solar panel cleaning device 30 of PTL 1, the mop 33 or the like rotates while moving on the solar panel 301 to perform cleaning by feeding and ejecting water from the cleaning hose 34.

However, a configuration with a cleaning mop 33 or the like alone has a problem that water remains on the solar panel 301 after cleaning and therefore dirt in the air is likely to be adhered before the panel being dried.

Moreover, there is a problem that dirt such as sand dust which has been deposited on the solar panel is mixed in the water after cleaning, so that this dirt is adhered again after being dried and remains in a mottled pattern, and cleaning is not uniformly performed. In order to prevent this, it is also considered to completely wash the dirt away with plenty of water, but in this case, another problem is caused that a usage amount of water is increased and cost required for cleaning becomes expensive. In particular, an area where the solar panel cleaning device is used is an area with poor water resource such as a desert/arid zone in many cases and increase in the usage amount of water becomes a large problem.

On the other hand, in the solar panel cleaning device of PTL 2, dirt is raised by the brush and water including the dirt on the solar panel is wiped off by the blade. However, water is only ejected toward the surface of the solar panel and there is a problem that dirt such as sand dust is deposited in an edge of the blade which wipes away water. In particular, in corporations, municipalities, electric power companies and the like, a larger-scale solar photovoltaic power generation plant called a mega solar power generation plant is operated. In the mega solar power generation plant, hundreds of thousands of solar panels are installed and all of these panels need to be cleaned. Accordingly, as many solar panels are cleaned repeatedly, a great deal of dirt such as sand dust is deposited in the blade. Wiping-away performance for water is degraded in the blade in which dirt is deposited and residual dirt or the like is caused, thus posing a problem that all the solar panels are not able to be cleaned uniformly.

In this manner, when a solar panel is cleaned without using a blade, there is a problem that because of wetting on the solar panel, dirt in the air is easily adhered and dirty water is dried to become water scale, thus causing uneven cleaning.

Moreover, even when a blade is used, as the solar panel is cleaned, dirt is deposited in an edge of the blade, thus posing a problem that wiping-away performance of the blade for water is degraded with cleaning operation and high cleaning capability is not able to be maintained.

The present invention has been made in view of the aforementioned problems, and an object thereof is to provide a cleaning device capable of suppressing uneven cleaning of a surface to be cleaned and maintaining cleaning capability over a long time period.

### Solution to Problem

In order to solve the aforementioned problems, a cleaning device according to one aspect of the present invention includes a nozzle that discharges liquid toward a surface to be cleaned and a blade that is an elastic member for wiping away the liquid on the surface to be cleaned, and is characterized in that when a plane that is in parallel to a tip end portion of the blade in contact with the surface to be cleaned and that is perpendicular to the surface to be cleaned is a reference plane, a hole in the nozzle is arranged so as to face the surface to be cleaned or arranged so as to be inclined to a side of the blade with respect to the reference plane.

### Advantageous Effects of Invention

According to one aspect of the present invention, an effect is exerted that it is possible to provide a cleaning device capable of suppressing uneven cleaning of a surface to be cleaned and maintaining cleaning capability over a long time period.

### BRIEF DESCRIPTION OF DRAWINGS

FIG. 1 is a cross-sectional view showing a schematic configuration of a cleaning device according to a first embodiment of the present invention;

FIG. 2(a) is a top view showing a state where the cleaning device is attached to a solar panel, and FIG. 2(b) is a side view showing a state where the cleaning device is attached to the solar panel;

FIG. 3(a) is a perspective view for explaining an arrangement relation between a blade and a nozzle shown in FIG. 2(b) and FIG. 3(b) is a perspective view showing a modified example of the arrangement relation between the blade and the nozzle shown in FIG. 3(a);

FIG. 4 is a perspective view for explaining a region where water is discharged by a nozzle included in a cleaning device according to a second embodiment of the present invention;

FIG. 5 is a perspective view showing a modified example of the region where water is discharged by the nozzle show in FIG. 4;

FIG. 6 is a perspective view for explaining a region where water is discharged by a nozzle included in a cleaning device according to a third embodiment of the present invention;

FIG. 7 is a perspective view showing a modified example of the region where water is discharged by the nozzle show in FIG. 6; and

FIG. 8 is a top view showing a conventional solar panel cleaning device.

### DESCRIPTION OF EMBODIMENTS

### First Embodiment

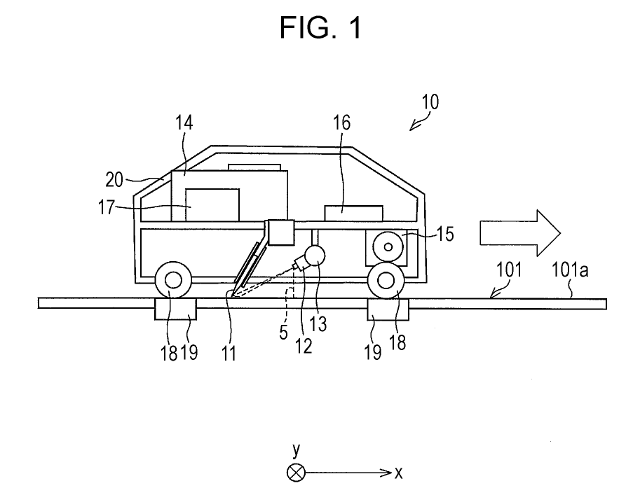

A first embodiment of the present invention will be described as follows based on FIG. 1 to FIG. 3. In the following description, same reference signs are assigned to same members or corresponding members in the figures and description thereof will not be repeated. Note that, though description will be given for a solar panel cleaning device in the following embodiment, a form of the present invention is not limited to the solar panel cleaning device and may be any cleaning device as long as being utilized for a substantially flat portion such as a roof or a floor.

### (Configuration of Cleaning Device 10)

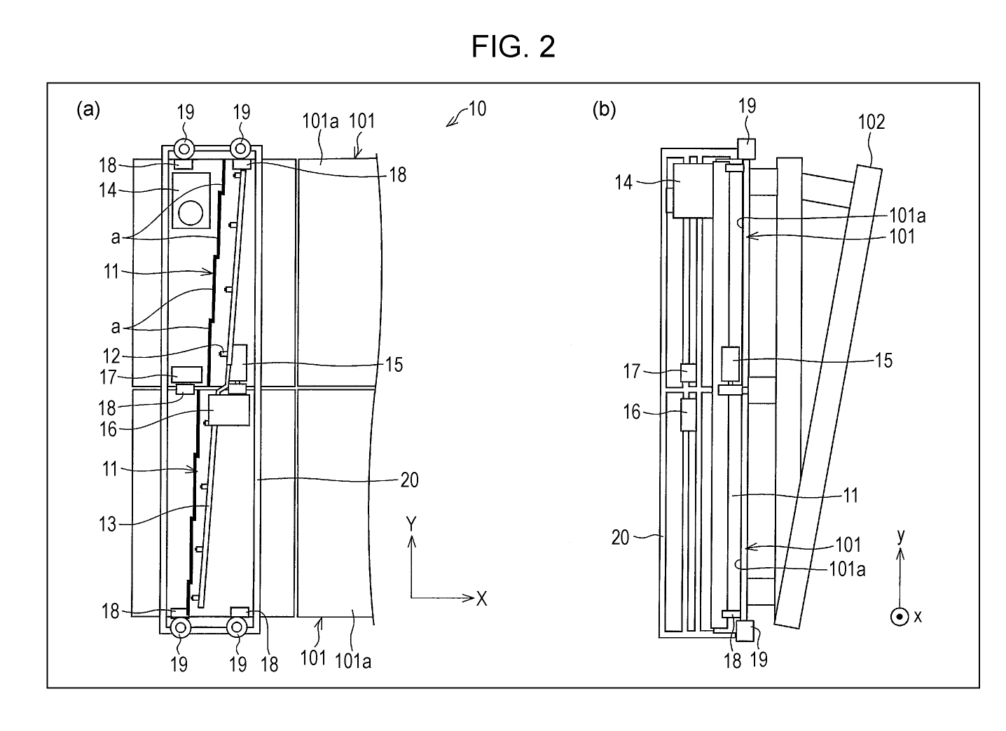

First, description will be given for a configuration of a cleaning device 10 according to the present embodiment with reference to FIG. 1 and FIG. 2.

FIG. 1 is a cross-sectional view showing a schematic configuration of the cleaning device 10 according to the first embodiment of the present invention. FIG. 1 shows a state where the cleaning device 10 is attached to a solar panel 101.

As shown in FIG. 1, the cleaning device 10 includes a blade 11, a nozzle 12, a piping 13, a tank 14, a motor 15, a control circuit 16, a power source 17, tires 18, guides 19 and a frame 20.

Note that, in the following, an advancing direction of the cleaning device 10 is set as an X direction, and a direction that is in parallel to a light-receiving surface (surface to be cleaned) 101a of the solar panel 101 and that is orthogonal to the X direction is set as a Y direction.

FIG. 2(a) is a top view showing a state where the cleaning device 10 is attached to the solar panel 101, and FIG. 2(b) is a side view showing a state where the cleaning device 10 is attached to the solar panel 101. As shown in FIG. 2(a) and FIG. 2(b), the cleaning device 10 is attached to the solar panel 101 by causing the tires 18 to make contact with the light-receiving surface 101a of the solar panel 101 and holding both ends (upper and lower ends) of the solar panel 101 between the guides 19.

The solar panel 101 is normally installed on a pedestal 102 so as to be inclined by around 10° to 30° from a horizontal direction in many cases so that solar light is incident on the light-receiving surface 101a of the solar panel 101 perpendicularly as much as possible. Therefore, the guides 19 function to prevent the cleaning device 10 from being detached or fallen from the solar panel 101. That is, only with frictional force of the tires 18, there is a possibility that the cleaning device 10 slips down the light-receiving surface 101a of the inclined solar panel 101 and falls from the solar panel 101. In order to prevent this, the cleaning device 10 is attached to the solar panel 101 so as to hold the upper and lower ends of the solar panel 101 between the guides 19. Further, the guides 19 function to support the cleaning device 10 to be movable linearly in the advancing direction (x direction) on the solar panel 101.

The blade 11 wipes away water (liquid) on the light-receiving surface 101a discharged from a hole in the nozzle 12. The blade 11 is arranged so that an edge (tip end portion) in contact with the light-receiving surface 101a of the solar panel 101 is substantially in parallel to the light-receiving surface 101a. Moreover, the blade 11 is fixed to the frame 20 so as to be inclined to an upstream side of the advancing direction of the cleaning device 10 by around 30° to 45° with respect to a normal line direction of the light-receiving surface 101a of the solar panel 101. A reason why the blade 11 is fixed so as to be inclined is for improving wiping-away property for water for cleaning the light-receiving surface 101a.

As a material of the blade 11, a material having elasticity is preferably used in consideration of wiping-off performance for water and dirt and weathering resistance. For example, as the blade 11, a rubber blade using EPT rubber, urethane rubber or the like is suitably usable.

In the present embodiment, the cleaning device 10 includes two blades 11 according to the number of stages of the solar panel 101 arranged in upper and lower two stages. Each of the blades 11 is fixed to the frame 20 so as to be slightly inclined by around 1° to 5° with respect to the Y direction so that an end portion positioned on an upper end side of the solar panel 101 precedes at the time of advancing. Thereby, when the cleaning device 10 advances, a force for pushing out water on the light-receiving surface 101a of the solar panel 101 to be wiped by the blade 11 to an inclination direction of the blade 11 works, and the water is able to be discharged smoothly from the light-receiving surface 101a of the solar panel 101. Further, by inclining the blade 11 slightly, the blade 11, when riding over a step around the solar panel 101, comes to ride over the step from a site abutted first gradually, thus making it possible to reduce a load at the time of riding over.

Moreover, the blade 11 on the upper stage side and the blade 11 on the lower stage side are separated at a position passing through a convex-shaped fastener (not shown in the figures) such as a bolt and a nut connecting the solar panels 101. Therefore, it is possible to avoid that the blade 11 abuts the fastener and is damaged or the blade 11 is caught by the fastener so that the cleaning device 10 does not move. Further, it is possible to avoid that wiping remnant of water is caused on the solar panel 101 in a vicinity of the fastener, etc.

Moreover, in each of the blades 11, end portions of a plurality of blade fragments 11a are jointed with each other along an extension direction of an edge. In normal continuous blades, for example, when the blades are attached to a large-sized cleaning device, a dimension of the blades becomes long and the blades with a length corresponding to a size of a cleaning target object such as a solar panel need to be made individually. Therefore, maintenance property for attaching and replacing of the blades is deteriorated and further cost of making the blades becomes expensive.

Against this, in the blade 11 according to the present embodiment, by changing the number of the blade fragments 11a to be jointed with each other, it is possible to change a length of the blade 11 easily. Therefore, it is possible to reduce cost of making the blade 11 and it is further possible to improve maintenance property for attaching and replacing of the blade 11.

The nozzle 12 has one or a plurality of holes and discharges liquid such as water or cleaning liquid for cleaning the light-receiving surface 101a of the solar panel 101 from this hole. Each nozzle 12 is jointed to the tank 14 through the piping 13 and discharges water retained in the tank 14.

Since the light-receiving surface 101a of the solar panel 101 is cleaned by using water in the cleaning device 10, the nozzle 12 is preferably configured with a material excellent in lightweight/rustproof performance such as aluminum.

In the present embodiment, as to the blade 11 and the nozzle 12, the blade 11 and the nozzle 12 are arranged in this order along the advancing direction (x direction). This is for splashing water on the solar panel 101 by the nozzle 12 and cleaning the light-receiving surface 101a of the solar panel 101 while wiping by the blade 11.

Note that, when cleaning is performed while moving in a minus x direction, an arrangement order of the nozzle 12 and the blade 11 needs to be reversed. In this case, arrangement of the nozzle 12 and the blade 11 may be replaced to be used by rotating the cleaning device by 180° to attach to the solar panel 101, etc. Alternatively, one more set of the nozzle 12 and the blade 11 in which the arrangement order is reversed may be added to the cleaning device 10 so as to allow forward and backward cleaning.

Here, when a plane that is in parallel to the edge of the blade 11 in contact with the light-receiving surface 101a and that is perpendicular to the light-receiving surface 101a is set as a reference plane S, the hole in the nozzle 12 is arranged so as to face the surface to be cleaned or arranged so as to be inclined to a side of the blade 11 with respect to the reference plane S. Therefore, much more water is able to be discharged to the side of the blade 11 and directed toward the blade 11, so that it is possible to increase a quantity of water supplied to a part where the light-receiving surface 101a and the blade 11 make contact. A flow of the much more water supplied to the part where the light-receiving surface 101a and the blade 11 make contact acts so as not only to remove dirt such as sand dust accumulated on the light-receiving surface 101a but to clear dirt adhered to the blade 11, thus making it possible to keep the blade 11 clean over a long time period.

Further, a discharge angle of the nozzles 12 may be set so as to discharge all water to the side of the blade 11 with respect to the reference plane S passing through the nozzle 12. This makes it possible to further increase the quantity of water supplied to the part where the light-receiving surface 101a and the blade 11 make contact, thus making it possible to clear the dirt adhered to the blade 11 effectively.

Furthermore, the nozzle 12 may be arranged so that a part of discharged water is blown to the blade 11 directly. This makes it possible to clear the dirt adhered to the blade 11 effectively with the water which is blown directly. In this case, the nozzle 12 is preferably arranged so as to discharge water toward the edge of the blade 11 from an oblique direction with respect to the blade 11. The dirt on the light-receiving surface 101a that is wiped away by the blade 11 is normally accumulated in the edge of the blade 11 in large amount. Therefore, since the nozzle 12 discharges liquid toward the edge of the blade 11 from the oblique direction with respect to the blade, it is possible to clean the dirt adhered to the edge of the blade 11 more effectively.

Note that, operation of the cleaning device 10 is performed when the motor 15 drives the tire 18. Though the present embodiment has a one-wheel driving form in which a rotational axis of the motor 15 is directly coupled to the nearest tire 18, but may have two-wheel driving or four-wheel driving by transferring driving force of the motor to each tire with a shaft, a bearing, a timing belt and the like.

The control circuit 16 controls supplying of water from the tank 14 and driving of the motor 15. Specifically, the control circuit 16 controls power supplied from the power source 17 and controls a quantity of water supplied from the tank 14 to the piping 13. Moreover, the control circuit 16 controls the power supplied from the power source 17 and controls ON/OFF of the motor 15, a driving speed, a rotation direction and the like.

Note that, though the power source 17 such as a battery is mounted in the cleaning device 10 in the present embodiment, power may be supplied directly from an external power source without including the power source 17. When power is supplied to the cleaning device 10 directly from the external power source, however, the cleaning device 10 needs to be connected to the external power source with a power source cord. In this case, the power source cord is likely to be caught by the solar panel 101 and an obstacle therearound to prevent driving of the cleaning device 10. Accordingly, the power source 17 is preferably mounted in the cleaning device 10 like in the present embodiment.

All components of the cleaning device 10 are fixed directly or indirectly to the frame 20. The frame 20 is preferably configured by a material which has excellent weathering resistance because the cleaning device 10 is used outdoors and further water is used to perform cleaning. Moreover, since the cleaning device 10 is installed so as to cover a longitudinal direction of the solar panel 101 which are arranged in the upper and lower two stages and a size of the cleaning device 10 itself becomes 3 m or more, the frame 20 is required to have high stiffness and a low weight. In the present embodiment, an aluminum member which is a metal member with light weight and having excellent rust prevention performance is used for the frame 20 to provide a frame structure having excellent stiffness such as a truss structure, thus seeking lightweight.

(Arrangement Relation between Blade 11 and Nozzle 12)

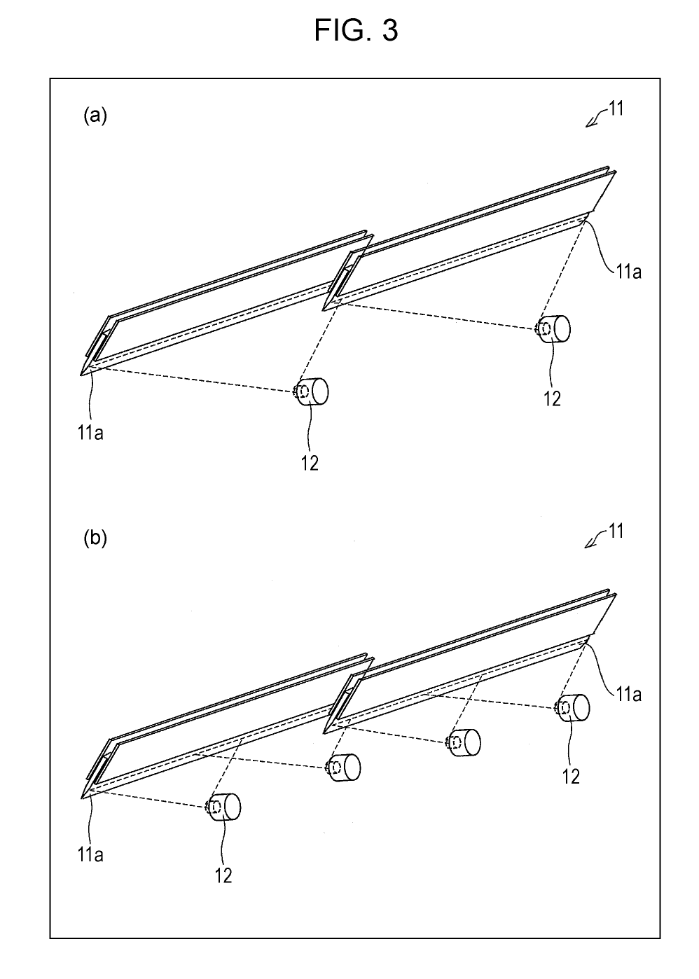

Next, description will be given for an arrangement relation between the blade 11 and the nozzle 12 included in the cleaning device 10 according to the present embodiment with reference to FIG. 3.

FIG. 3(a) is a perspective view for explaining the arrangement relation between the blade 11 and the nozzle 12 shown in FIG. 2(b) and FIG. 3(b) is a perspective view showing a modified example of the arrangement relation between the blade 11 and the nozzle 12 shown in FIG. 3(a).

As shown in FIG. 3(a), the nozzle 12 is arranged for each of the blade fragments 11a which constitute the blade 11. Here, the nozzle 12 is arranged at a position where a seam (end portions) of the blade fragments 11a and the hole in the nozzle 12 do not overlap when viewed from a direction perpendicular to the reference plane S. This is because the blade 11 is configured by combining the plurality of blade fragments 11a as described above, so that water leaks from the seam of the blade fragments 11a and comes around to a rear side of the blade 11 in some cases. The water coming around to the rear side of the blade 11 contains dirt and leads to adhering of dirt again when being dried. Therefore, when a plenty of water is discharged toward the seam of the blade fragments 11a, water leaks from the seam and comes around to the rear side of the blade 11 easily, which is not preferable. In order to prevent this, the nozzle 12 is arranged at the position where the seam of the blade fragments 11a and the hole in the nozzle 12 do not overlap when viewed from the direction perpendicular to the reference plane S. That is, since the hole in the nozzle 12 is arranged at a position not directly opposing to the seam of the blade fragments 11a, it is possible to relatively reduce a quantity of water supplied to the seam of the blade fragments 11a.

Specifically, the nozzle 12 is preferably arranged at a position where a vicinity of a center portion of the blade fragment 11a directly opposes the hole in the nozzle 12. Thereby, since water becomes difficult to leak from the seam of the blade fragments 11a, it is possible to suppress adhering of dirt again.

Note that, as shown in FIG. 3(b), two or more nozzles 12 may be arranged for each of the blade fragments 11a which constitute the blade 11. In this case as well, the hole in the nozzle 12 may be arranged at the position directly opposing the vicinity of the center portion of the blade fragment 11a so that much more water is discharged to a region other than the seam of the blade fragments 11a.

Moreover, one nozzle 12 may be arranged for each plurality of blade fragments 11a which constitute the blade 11. This makes it possible to reduce the number of the nozzles 12 to be arranged, thus making it possible to reduce cost of the cleaning device 10.

### (Effect of Cleaning Device 10)

Next, description will be given for an effect of the cleaning device 10 according to the present embodiment. The cleaning device 10 includes the blade 11 which wipes away water on the light-receiving surface 101a, and is therefore able to reduce wiping remnant of water on the light-receiving surface 101a compared to a conventional configuration not including the blade 11. Thus, according to the cleaning device 10, it is possible to suppress uneven cleaning of the light-receiving surface 101a by suppressing adhering of dirt again and generation of water scale and the like, which are caused when water that is left being unwiped is dried.

Further, in the cleaning device 10, since the hole in the nozzle 12 is arranged so as to face the surface to be cleaned or arranged so as to be inclined to the side of the blade 11 with respect to the reference plane S that is in parallel to the edge of the blade 11 in contact with the light-receiving surface 101a and that is perpendicular to the light-receiving surface 101a, much more water is able to be discharged to the side of the blade 11 and directed toward the blade 11. Therefore, compared to a conventional configuration in which water is discharged to a direction on an opposite side to a direction in which the blade 11 is arranged, it is possible to increase the quantity of water supplied to the part where the light-receiving surface 101a and the blade 11 make contact. As described above, since a flow of the much more water supplied to the part where the light-receiving surface 101a and the blade 11 make contact acts so as not only to remove the dirt such as sand dust accumulated on the light-receiving surface 101a but to clear the dirt adhered to the blade 11, it is possible to keep the blade 11 clean over a long time period.

That is, the blade 11 wipes away the dirt accumulated on the light-receiving surface 101a at the same time with water, but dirt is deposited in the edge of the blade 11 with cleaning of the light-receiving surface 101a, thus posing a problem that wiping-away performance for water is degraded with cleaning operation and high cleaning capability is not able to be maintained.

Moreover, the water which is discharged to the direction on the opposite side to the direction in which the blade 11 is arranged only raises sand dust temporarily by wetting the light-receiving surface 101a, and most part of the water flows down from the inclined light-receiving surface 101a before being wiped away by the blade 11, so that a quantity of water supplied to the edge of the blade 11 is reduced. Therefore, sand dust is easily accumulated in the blade 11 and cleaning capability of the blade 11 is degraded.

Thus, in the cleaning device 10, by arranging the holes in the nozzle 12 so as to face the surface to be cleaned or so as to be inclined to the side of the blade 11 with respect to the reference plane S, much more water is discharged to the side of the blade 11. This makes it possible to increase the quantity of water supplied to the part where the light-receiving surface 101a and the blade 11 make contact, so that a flow of this water makes it possible to clear the dirt adhered to the blade 11. Moreover, by discharging much more water to the side of the blade 11, even when the solar panel 101 is arranged so as to be inclined like in the present embodiment, the water discharged to the light-receiving surface 101a is able to be wiped away by the blade 11 before flowing down, so that the quantity of water supplied to the edge of the blade 11 is kept and it is possible to maintain a cleaning effect of the blade 11.

Thus, according to the present embodiment, it is possible to realize the cleaning device 10 capable of suppressing uneven cleaning of the light-receiving surface 101a and maintaining cleaning capability over a long time period.

Note that, the present invention may be realized as a cleaning system of the solar panel 101 that includes the cleaning device 10, and further has a sensing function of detecting a residual quantity of water in the tank 14 to perform automatic stop and operation, a sensing function of detecting an end portion of a row of the solar panel 101 to perform automatic stop, and/or a lifter/automatic guided vehicle for moving the cleaning device 10 to a next row when many rows of the solar panel 101 exist, etc. This cleaning system is a system which operates the cleaning device 10 appropriately in accordance with a configuration of a solar photovoltaic power generation device and which has flexibility capable of dealing with also a large-sized solar panel.

### Embodiment 2

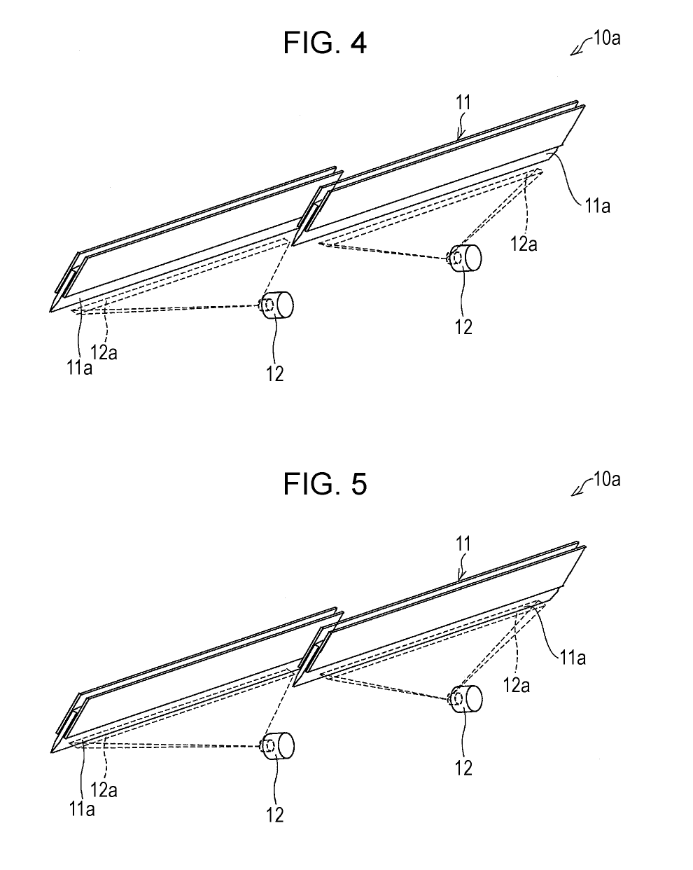

A second embodiment of the present invention will be described as follows based on FIG. 4 and FIG. 5. Note that, for convenience of description, same reference signs are assigned to members having same functions as those of the members described in the aforementioned embodiment and description thereof will be omitted.

Description will be given in the present embodiment for a cleaning device 10a which discharges water from the hole in the nozzle 12 toward a linear region 12a which is substantially in parallel to the blade 11.

FIG. 4 is a perspective view for explaining a region where water is discharged by the nozzle 12 included in the cleaning device 10a according to the present embodiment. As shown in FIG. 4, in the cleaning device 10a, each of the nozzles 12 discharges water toward the linear region 12a which is substantially in parallel to the edge of the blade 11. An effect thereof will be described below.

By discharging water from the nozzle 12 toward the linear region 12a which is substantially in parallel to an edge of the blade fragment 11a, water is able to be blown uniformly over a wide range along an edge direction of the blade 11.

Accordingly, by discharging water toward a vicinity of the part where the blade 11 and the light-receiving surface 101a make contact as shown in FIG. 4, it is possible to supply much more water uniformly to the part where the blade 11 and the light-receiving surface 101a make contact, thus making it possible to clear the dirt adhered to the blade 11 efficiently.

Moreover, since it is possible to discharge water to the wide range along the edge of the blade 11 from one nozzle 12, it is possible to reduce the number of the nozzles 12 to be installed and reduce cost of the cleaning device 10a.

In this manner, the water from the nozzle 12 is discharged toward the linear region 12a which is substantially in parallel to the edge of the blade 11 in the cleaning device 10a. Therefore, water is able to be blown uniformly over the wide range along the edge of the blade 11, thus making it possible to improve cleaning capability of the cleaning device 10a with respect to the blade 11.

Thus, according to the present embodiment, it is possible to realize the cleaning device 10a capable of suppressing uneven cleaning of the light-receiving surface 101a and maintaining cleaning capability over a long time period as well as having improved cleaning capability with respect to the blade 11 at low cost.

Note that, though description has been given in the present embodiment for a case where water is discharged from the nozzle 12 toward the linear region 12a positioned in the vicinity of the part where the blade 11 and the light-receiving surface 101a make contact, the present invention is not limited thereto. The nozzle 12 may be arranged so that a part of the water discharged from the nozzle 12 is directly blown to the blade 11.

FIG. 5 is a perspective view showing a modified example of the region where water is discharged by the nozzle 12 shown in FIG. 4. As shown in FIG. 5, water may be discharged from the nozzle 12 so that the part where the blade 11 and the light-receiving surface 101a make contact is included in the linear region 12a. In this case, since a part of the water discharged from the nozzles 12 is directly blown to the blade 11, it is possible to clear the dirt adhered to the blade 11 effectively.

Moreover, as described above, since the solar panel 101 is installed being inclined so that solar light is incident on the light-receiving surface 101a perpendicularly as much as possible, water blown to the blade 11 is transferred from the edge of the blade 11 to the light-receiving surface 101a and easily flows downward of the light-receiving surface 101a. Therefore, it is possible to clear the dirt of the blade 11 with water blown to the blade 11 from the nozzle 12 as well as to raise the dirt (such as sand dust) accumulated on the light-receiving surface 101a with water transferred from the edge of the blade 11 to the light-receiving surface 101a and water directly discharged to the light-receiving surface 101a to remove with the blade 11.

### Embodiment 3

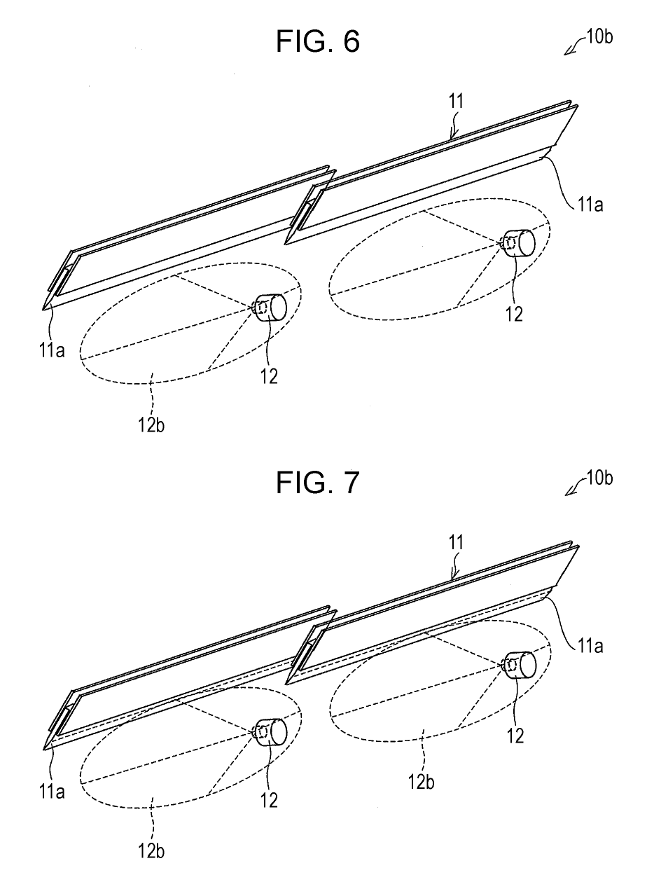

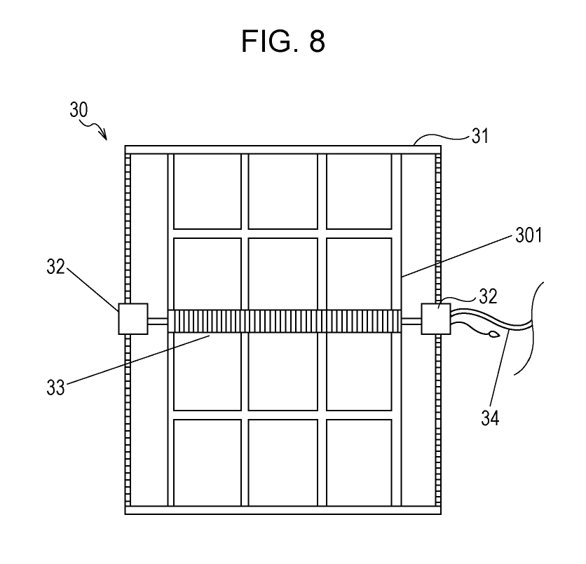

A third embodiment of the present invention will be described as follows based on FIG. 6 and FIG. 7. Note that, for convenience of description, same reference signs are assigned to members having same functions as those of the members described in the aforementioned embodiments and description thereof will be omitted.

Description will be given in the present embodiment for a cleaning device 10b which discharges water from the nozzle 12 toward a circular region 12a on the light-receiving surface 101a.

FIG. 6 is a perspective view for explaining a region where water is discharged by the nozzle 12 included in the cleaning device 10b according to the present embodiment. As shown in FIG. 6, in the cleaning device 10b, each of the nozzles 12 discharges water toward the circular region 12a. An effect thereof will be described below.

By discharging water from the nozzle 12 toward the circular region 12b, it is possible to supply water not only to the vicinity of the part where the blade 11 and the light-receiving surface 101a make contact but also onto the light-receiving surface 101a separated from the blade 11, which is positioned on a downstream side of an advancing direction of the cleaning device 10b.

Accordingly, it becomes possible that not only the dirt of the blade 11 and on the light-receiving surface 101a in the vicinity of the part where the blade 11 and the light-receiving surface 101a make contact but the dirt accumulated on the light-receiving surface 101a separated from the blade 11, which is positioned on the downstream side of the advancing direction of the cleaning device 10b, are raised with water in advance and removed by the blade 11 easily, thus making it possible to clean the light-receiving surface 101a effectively.

In this manner, the water from the nozzle 12 is discharged toward the circular region 12b on the light-receiving surface 101a in the cleaning device 10b. Therefore, it becomes possible that the dirt accumulated on the light-receiving surface 101a separated from the blade 11, which is positioned on the downstream side of the advancing direction of the cleaning device 10b, is raised with water in advance and removed by the blade 11 easily, thus making it possible to improve cleaning capability of the cleaning device 10b with respect to the light-receiving surface 101a.

Thus, according to the present embodiment, it is possible to realize the cleaning device 10b capable of suppressing uneven cleaning of the light-receiving surface 101a and maintaining cleaning capability over a long time period as well as having improved cleaning capability with respect to the light-receiving surface 101a.

Note that, though description has been given in the present embodiment for a case where water is discharged from the nozzle 12 toward the circular region 12b positioned in the vicinity of the part where the blade 11 and the light-receiving surface 101a make contact, the present invention is not limited thereto. The nozzle 12 may be arranged so that a part of the water discharged from the nozzle 12 is directly blown to the blade 11.

FIG. 7 is a perspective view showing a modified example of the region where water is discharged by the nozzles 12 show in FIG. 6. As shown in FIG. 7, the water may be discharged from the nozzle 12 so that the part where the blade 11 and the light-receiving surface 101a make contact is included in the circular region 12b. In this case, since a part of the water discharged from the nozzle 12 is directly blown to the blade 11, it is possible to clear the dirt adhered to the blade 11 more effectively.

### [Overview]

A cleaning device according to an aspect 1 of the present invention includes a nozzle that discharges liquid (water) for cleaning toward a surface to be cleaned (light-receiving surface 101a) and a blade that is an elastic member for wiping away the liquid on the surface to be cleaned, and is characterized in that when a plane that is in parallel to a tip end portion (edge) of the blade in contact with the surface to be cleaned and that is perpendicular to the surface to be cleaned is a reference plane, a hole in the nozzle is arranged so as to face the surface to be cleaned or arranged so as to be inclined to a side of the blade with respect to the reference plane.

In the aforementioned configuration, since the blade that wipes away the liquid on the surface to be cleaned is included, it is possible to reduce wiping remnant of the liquid on the surface to be cleaned compared to a conventional configuration not including a blade. Accordingly, with the aforementioned configuration, it is possible to suppress uneven cleaning of the surface to be cleaned by suppressing adhering of dirt again and generation of water stain and the like, which are caused when liquid that is left being unwiped is dried.

Further, in the aforementioned configuration, since the hole in the nozzle is arranged so as to face the surface to be cleaned or arranged so as to be inclined to the side of the blade with respect to the reference plane that is in parallel to the tip end portion of the blade in contact with the surface to be cleaned and that is perpendicular to the surface to be cleaned, much more liquid is able to be discharged to the side of the blade and directed toward the blade. Therefore, compared to a conventional configuration in which liquid is discharged to a direction on an opposite side to a direction in which a blade is arranged with respect to a surface to be cleaned, it is possible to increase a quantity of liquid supplied to a part where the surface to be cleaned and the blade make contact. A flow of much more liquid supplied to the part where the surface to be cleaned and the blade make contact acts so as not only to remove dirt such as sand dust on the surface to be cleaned but to clear dirt adhered to the blade, thus making it possible to keep the blade clean over a long time period.

Accordingly, with the aforementioned configuration, it is possible to realize the cleaning device capable of suppressing uneven cleaning of the surface to be cleaned and maintaining cleaning capability over a long time period.

Moreover, in a cleaning device according to an aspect 2 of the present invention, it is preferable that the nozzle discharges the liquid toward a linear region on the surface to be cleaned, which is substantially in parallel to the tip end portion in the aforementioned aspect 1.

In the aforementioned configuration, since the nozzle discharges the liquid toward the linear region on the surface to be cleaned, the linear region being substantially in parallel to the tip end portion of the blade, it becomes possible to uniformly blow the liquid over a wide range along the tip end portion of the blade.

Accordingly, with the aforementioned configuration, for example, by discharging the liquid so as to include the part where the blade and the surface to be cleaned make contact or toward a vicinity thereof, it is possible to supply much more liquid uniformly to the part where the blade and the surface to be cleaned make contact, thus making it possible to clear the dirt adhered to the blade more efficiently.

Moreover, with the aforementioned configuration, since it is possible to discharge the liquid to the wide range along the tip end portion of the blade from one nozzle, it is possible to reduce the number of nozzles to be installed and reduce cost of the cleaning device.

Moreover, in a cleaning device according to an aspect 3 of the present invention, it is preferable that the nozzle discharges the liquid toward a circular region on the surface to be cleaned in the aforementioned aspect 1.

In the aforementioned configuration, since the nozzle discharges the liquid toward the circular region on the surface to be cleaned, it becomes possible to discharge the liquid not only to the part where the blade and the surface to be cleaned make contact or the vicinity thereof, but also onto the surface to be cleaned separated from the blade, which is positioned on a downstream side with respect to an advancing direction of the cleaning device.

Accordingly, with the aforementioned configuration, since it is possible that dirt accumulated on the surface to be cleaned separated from the blade, which is positioned on the downstream side of the advancing direction of the cleaning device, is raised with the liquid in advance and removed by the blade easily, it is possible to improve cleaning capability of the cleaning device with respect to the surface to be cleaned.

Moreover, in a cleaning device according to an aspect 4 of the present invention, it is preferable that the nozzle discharges the liquid from an oblique direction with respect to the blade toward the tip end portion in any of the aforementioned aspects 1 to 3.

Normally, the dirt on the surface to be cleaned that is wiped away by the blade is accumulated in the tip end portion of the blade in large amount. With the aforementioned configuration, since the nozzle discharges the liquid toward the tip end portion of the blade from the oblique direction with respect to the blade, it is possible to clean the dirt adhered to the tip end portion of the blade effectively.

Moreover, in a cleaning device according to an aspect 5 of the present invention, it is preferable that the blade is configured by jointing end portions of a plurality of blade fragments with each other along an extension direction of the tip end portion, and the hole in the nozzle is arranged at a position not overlapping with a seam of the blade fragments when viewed from a direction perpendicular to the reference plane in any of the aforementioned aspects 1 to 4.

In a normal continuous blade, for example, when the blade is attached to a large-sized cleaning device, a dimension of the blade becomes long and the blade with a length corresponding to a size of a surface to be cleaned needs to be made individually. Therefore, cost of making the blade becomes expensive and further maintenance property for attaching and replacing of the blade is also deteriorated.

Against this, in the aforementioned configuration, since the blade is configured by jointing the end portions of the plurality of blade fragments with each other along the extension direction of the tip end portion of the blade, by changing the number of the blade fragments to be jointed, it is possible to change the length of the blade easily.

Accordingly, with the aforementioned configuration, it becomes possible to reduce cost of making the blade and it is further possible to improve maintenance property for attaching and replacing of the blade.

Here, in the blade which is configured by jointing the plurality of blade fragments, liquid discharged from the nozzle leaks from the seam of the blade fragments and comes around to a rear side of the blade in some cases. The liquid coming around to the rear side of the blade contains dirt and leads to adhering of dirt again when being dried. Therefore, when a plenty of liquid is discharged toward the seam of the blade fragments, liquid leaks from the seam and easily comes around to the rear side of the blade, which is not preferable.

In the aforementioned configuration, in order to prevent this, the hole in the nozzle is arranged at the position not overlapping with the seam of the blade fragments when viewed from the direction perpendicular to the reference plane. That is, since the hole in the nozzle is arranged at a position not directly opposing to the seam of the blade fragments, it becomes possible to relatively reduce a quantity of liquid supplied to the seam of the blade fragments.

Accordingly, with the aforementioned configuration, since the liquid becomes difficult to leak from the seam of the blade fragments, it becomes possible to suppress adhering of dirt to the surface to be cleaned again.

The present invention is not limited to each of the embodiments described above, various modifications are possible in the scope indicated in Claims, and an embodiment acquired by combining appropriately technical means each disclosed in a different embodiment is also included in the technical scope of the present invention. Further, by combining technical means each disclosed in each embodiment, a new technical feature is able to be formed.

### [Supplement]

Note that, the present invention is also able to be expressed as follows. That is, the cleaning device according to the present invention includes a blade made of an elastic member and a nozzle that supplies water, and is characterized by being arranged so that water is blown from the nozzle to a direction of the blade.

Moreover, in the cleaning device according to the present invention, the nozzle that supplies the water may spray the water linearly in the direction of the blade.

Moreover, in the cleaning device according to the present invention, the nozzle that supplies the water may spray the water circularly in the direction of the blade.

Moreover, in the cleaning device according to the present invention, the nozzle that supplies the water may be arranged so as to spray the water from an oblique direction to a tip end portion of the blade.

Moreover, in the cleaning device according to the present invention, the blade may be arranged with a plurality of blades arrayed.

Moreover, in the cleaning device according to the present invention, the nozzle that supplies the water may be arranged at a site separated from an end of the blade.

### INDUSTRIAL APPLICABILITY

The present invention is suitably usable for a cleaning device that cleans a solar panel, an arcade, a general home roof, a corridor and the like, and a cleaning system.

### REFERENCE SIGNS LIST

10 cleaning device
10a cleaning device
10b cleaning device
11 blade
11a blade fragment
12 nozzle
12a linear region
12b circular region
13 piping
14 tank
15 motor
16 control circuit
17 power source
18 tire
19 guide
20 frame
101 solar panel
101a light-receiving surface (surface to be cleaned)
S reference plane

1. A cleaning device, comprising:
a nozzle that discharges liquid toward a surface to be cleaned; and
a blade that is an elastic member for wiping away the liquid on the surface to be cleaned, wherein
when a plane that is in parallel to a tip end portion of the blade in contact with the surface to be cleaned and that is perpendicular to the surface to be cleaned is a reference plane, a hole in the nozzle is arranged so as to face the surface to be cleaned or arranged so as to be inclined to a side of the blade with respect to the reference plane.

2. The cleaning device according to claim 1, wherein the nozzle discharges the liquid toward a linear region on the surface to be cleaned, the linear region being substantially in parallel to the tip end portion.

3. The cleaning device according to claim 1, wherein the nozzle discharges the liquid toward a circular region on the surface to be cleaned.

4. The cleaning device according to claim 1, wherein the nozzle discharges the liquid from an oblique direction with respect to the blade toward the tip end portion.

5. The cleaning device according to claim 1, wherein
the blade is configured by jointing end portions of a plurality of blade fragments with each other along an extension direction of the tip end portion, and
the hole in the nozzle is arranged at a position not overlapping with a seam of the blade fragments when viewed from a direction perpendicular to the reference plane.
